(19) United States
(12) Patent Application Publication
(10) Pub. No.: US 2007/0103602 A1
(43) Pub. Date: May 10, 2007

(54) DIGITAL TERRESTRIAL BROADCAST TUNER MODULE AND DIGITAL TERRESTRIAL BROADCAST RECEIVER

(75) Inventor: Mitsuru Ikeda, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/538,335

(22) Filed: Oct. 3, 2006

(30) Foreign Application Priority Data
Oct. 7, 2005 (JP) P2005-295431

(51) Int. Cl. H04N 5/46

(52) U.S. Cl. 348/729; 348/731

(57) ABSTRACT

A digital terrestrial broadcast tuner module and digital terrestrial broadcast receiver are provided. The digital terrestrial broadcast tuner module that allows reception of both a digital terrestrial television broadcast and a digital terrestrial radio broadcast, which includes a first frequency converter configured to convert a frequency of a received RF signal to thereby convert the received RF signal into a first intermediate frequency signal; a first band limiter configured to convert the first intermediate frequency signal into a second intermediate frequency signal with a bandwidth for reception of a digital terrestrial television broadcast; a second band limiter configured to convert the first intermediate frequency signal into a third intermediate frequency signal with a bandwidth for reception of a digital terrestrial radio broadcast; a selector configured to select either one of the second intermediate frequency signal and the third intermediate frequency signal; and a demodulator configured to demodulate the intermediate frequency signal selected by the selector.

### CROSS REFERENCE TO RELATED APPLICATIONS

The present application claims priority to Japanese Patent Application JP 2005-295431 filed in the Japanese Patent Office on Oct. 7, 2005, the entire contents of which is being incorporated herein by reference.

### BACKGROUND

The present application generally relates to a digital terrestrial broadcast receiver, and particularly to a digital terrestrial broadcast tuner module that allows reception of both digital terrestrial television broadcasting (ISDB-T) and digital terrestrial radio broadcasting (ISDB-TSB).

The digital terrestrial television broadcasting (ISDB-T) is television broadcasting in which, as shown by one example of the frequency sequence thereof in FIG. 4, thirteen segments each having a bandwidth of 429 kHz are coupled and OFDM-modulated so as to be transmitted by using an occupied bandwidth of 6 MHz. Of the thirteen segments, the center one segment is referred to as a partial-reception segment, and extraction and reception of only this segment are possible. A television service that utilizes this one segment and is oriented to cellular phones is supposed to start from year 2006.

As for the digital terrestrial radio broadcasting (ISDB-TSB), test broadcasting thereof is currently implemented in Tokyo and Osaka areas in such a manner that, as shown in FIG. 5, the band therefor is defined between the analog television broadcast bands of the VHF 6 CH and VHF 8 CH, and eight segments each having a bandwidth of 429 kHz are coupled and OFDM-modulated so as to be transmitted by using an occupied bandwidth of 4 MHz of the VHF 7 CH. In the future, it is planned that thirteen segments are coupled and broadcasted. In audio broadcasting, services are offered on each segment basis independently of each other and receivers receive any one segment or three segments optionally to thereby utilize the respective services.

In general, a digital terrestrial television broadcast receiver employs a tuner module for an occupied bandwidth of 6 MHz that receives all the thirteen segments (refer to e.g. Japanese Patent Laid-open No. 2001-346110 (p. 4, FIG. 1)). On the other hand, as a tuner module for a television broadcast service oriented to cellular phones and a tuner module for receiving a digital radio broadcast (refer to e.g. Japanese Patent Laid-open No. 2003-179513 (p. 6, FIG. 1)), a tuner module that receives only one segment or three segments is typically used in terms of low power consumption.

If television broadcasts and digital radio broadcasts are received by different receivers independent of each other, these receivers need to be placed at the respective proper positions, which leads to low space-saving efficiency. Furthermore, when a user switches the broadcast to be received between television and radio broadcasts, the placement of the receivers at separate positions provides extremely low operability. Therefore, it has been requested to develop a tuner module that can receive by itself alone both the television broadcasts and digital radio broadcasts, and a receiver that employs the tuner module.

### SUMMARY

The present application is made in consideration of the above-described circumstances, and there is a need for the invention to provide a digital terrestrial broadcast tuner module that can receive both television broadcasts and digital radio broadcasts, and a digital terrestrial broadcast receiver that employs the module.

According to an embodiment, there is provided a digital terrestrial broadcast tuner module that allows reception of both a digital terrestrial television broadcast and a digital terrestrial radio broadcast, and includes a first frequency converter configured to convert the frequency of a received RF signal to thereby convert the received RF signal into a first intermediate frequency signal, a first band limiter configured to convert the first intermediate frequency signal into a second intermediate frequency signal with a bandwidth for reception of a digital terrestrial television broadcast, and a second band limiter configured to convert the first intermediate frequency signal into a third intermediate frequency signal with a bandwidth for reception of a digital terrestrial radio broadcast. The tuner module further includes a selector configured to select either one of the second intermediate frequency signal and the third intermediate frequency signal, and a demodulator configured to demodulate the intermediate frequency signal selected by the selector.

According to another embodiment, there is provided a digital terrestrial broadcast tuner module that allows reception of both a digital terrestrial television broadcast and a digital terrestrial radio broadcast, and includes a first frequency converter configured to convert the frequency of a received RF signal to thereby convert the received RF signal into a first intermediate frequency signal, and a first band limiter configured to convert the first intermediate frequency signal into a second intermediate frequency signal with either one of a bandwidth for reception of a digital terrestrial television broadcast and a bandwidth for reception of a digital terrestrial radio broadcast. The tuner module further includes a selection controller configured to control the first band limiter so that the bandwidth of the second intermediate frequency signal is selected, and a demodulator configured to demodulate the second intermediate frequency signal output from the first band limiter through selection under control by the selection controller.

As described above, in an embodiment, a tuner module is provided with two-system intermediate frequency signal generating circuits that produce from a first intermediate frequency signal a second intermediate frequency signal having the band for reception of a digital terrestrial television broadcast and a third intermediate frequency signal having the band for reception of a digital terrestrial radio broadcast after the frequency of a received signal of a digital terrestrial broadcast is converted so that the received signal is converted into the first intermediate frequency signal. In this tuner module, either one of the second and third intermediate frequency signals is demodulated depending on the broadcast intended to be received. This configuration allows one tuner module to receive both digital terrestrial television and radio broadcasts.

In another embodiment, a tuner module is provided with a one-system intermediate frequency signal generating circuit that includes one filter circuit for selectively limiting the first intermediate frequency signal to either one of the bandwidth for reception of a digital terrestrial television broadcast and the bandwidth for reception of a digital terrestrial radio broadcast. This configuration allows one tuner module having desired adjacent-signal removal characteristics and a smaller circuit scale to selectively receive both digital terrestrial television and radio broadcasts with favorable characteristics. Thus, a digital terrestrial broadcast receiver that offers high space-saving efficiency when being placed can be realized.

According to an embodiment, a tuner module is provided with two-system band limiters: a first band limiter that converts a first intermediate frequency signal arising from conversion of the frequency of a received signal, into a signal with the bandwidth for reception of a digital terrestrial television broadcast; and a second band limiter that converts the first intermediate frequency signal into a signal with the bandwidth for reception of a digital terrestrial radio broadcast. Alternatively, a tuner module is provided with a one-system bandwidth limiter that selectively limits the first intermediate frequency signal to either one of the bandwidth for reception of a digital terrestrial television broadcast and the bandwidth for reception of a digital terrestrial radio broadcast. These configurations allow one tuner module to selectively receive both digital terrestrial television and radio broadcasts. Furthermore, providing one digital broadcast receiver with this tuner module enables the one digital broadcast receiver to receive both digital terrestrial television and radio broadcasts by itself alone and offer high space-saving efficiency when being placed.

Additional features and advantages are described herein, and will be apparent from, the following Detailed Description and the figures.

### BRIEF DESCRIPTION OF THE FIGURES

FIG. 1 is a block diagram showing the configuration of a digital terrestrial broadcast receiver according to an embodiment of the present invention.

FIG. 2 is a block diagram showing another example of the digital terrestrial broadcast receiver shown in FIG. 1.

FIG. 3 is a block diagram showing the configuration of a digital terrestrial broadcast receiver according to another embodiment of the invention.

FIG. 4 is a diagram for explaining one example of the frequency sequence of digital terrestrial television broadcasting (ISDB-T).

FIG. 5 is a diagram for explaining one example of the frequency sequence of digital terrestrial radio broadcasting (ISDB-TSB).

### DETAILED DESCRIPTION

A description that details various embodiments of the present invention is provided below.

The need to realize a tuner module that can receive both digital terrestrial television and radio broadcasts and a digital terrestrial broadcast receiver that employs this module is satisfied by the following two configurations. Specifically, in one configuration, a tuner module is provided with two-system band limiters: a first band limiter that converts a first intermediate frequency signal arising from conversion of the frequency of a received signal, into a signal with the bandwidth for reception of a digital terrestrial television broadcast; and a second band limiter that converts the first intermediate frequency signal into a signal with the bandwidth for reception of a digital terrestrial radio broadcast. In the other configuration, a tuner module is provided with a one-system bandwidth limiter that selectively limits the first intermediate frequency signal to either one of the bandwidth for reception of a digital terrestrial television broadcast and the bandwidth for reception of a digital terrestrial radio broadcast.

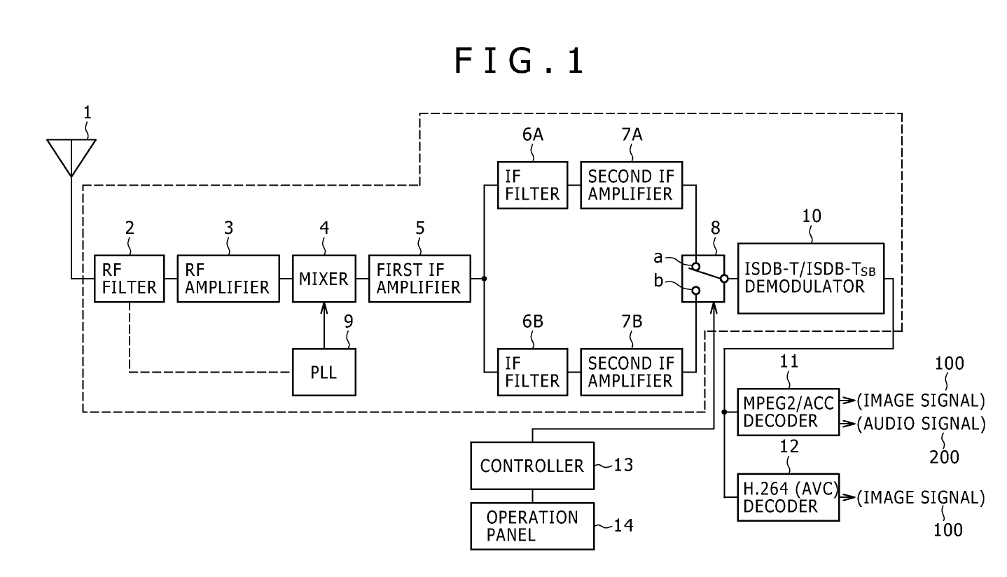

FIG. 1 is a block diagram showing the configuration of a digital terrestrial broadcast receiver according to an embodiment. The digital terrestrial broadcast receiver includes an antenna 1, an RF filter 2, an RF amplifier 3, a mixer 4, a first intermediate frequency (IF) amplifier 5, an IF filter 6A, an IF filter 6B, a second IF amplifier 7A, and a second IF amplifier 7B. In addition, the receiver includes also a broadcast changeover switch 8, a PLL 9, an ISDB-T/ISDB-TSB demodulator 10, an MPEG2/ACC decoder 11, an H.264 (AVC) decoder 12, a controller 13 that executes individual control such as reception-band changeover control and executes control of the entire receiver, and an operation panel 14. The part surrounded by the dashed line corresponds to a tuner module part that is formed of two-system IF circuits and can deal with both digital terrestrial television broadcasts and digital terrestrial radio broadcasts.

The operation will be described below. A received signal (received RF signal) input from the antenna 1 is subjected to band limitation in the RF filter 2 that synchronizes with the generation frequency of the PLL 9, and then is amplified by the RF amplifier 3, followed by being input to the mixer 4. The mixer 4 mixes the received signal with the frequency signal input from the PLL 9 to thereby convert the frequency of the received signal into a first IF of 57 MHz, which is lower than the reception frequency.

This IF signal is amplified by the first IF amplifier 5, followed by being distributed to the two systems. When a television broadcast is received, the IF signal output from the first IF amplifier 5 is limited to a band of 6 MHz by the IF filter 6A for a television broadcast. The resultant signal is amplified by the second IF amplifier 7A, followed by being input to a terminal a of the switch 8. At this time, the switch has been turned to the terminal a. Therefore, the IF signal limited to the band of 6 MHz is demodulated by the ISDB-T/ISDB-TSB demodulator 10. The demodulated signal is input to the MPEG2/ACC decoder 11 and is decoded into an image signal 100 and an audio signal 200, followed by being output.

On the other hand, when a digital audio broadcast is received, the IF signal output from the first IF amplifier 5 is limited to a band of 4 MHz by the IF filter 6B for a digital audio broadcast. The resultant signal is amplified by the second IF amplifier 7B and then is input via the switch 8 to the ISDB-T/ISDB-TSB demodulator 10. The signal demodulated by the ISDB-T/ISDB-TSB demodulator 10 is input to the MPEG2/ACC decoder 11 and is decoded into the audio signal 200, followed by being output. Simultaneously, the demodulated signal is input to the H.264 (AVC) decoder 12 and is decoded into an image signal 300, followed by being output.

The controller 13 turns the switch 8 based on a user's instruction input through the operation unit 14 in such a manner that it is turned to the terminal a when a digital television broadcast is received while it is turned to a terminal b when a digital radio broadcast is received. Thus, desired broadcasts can be selectively received by one receiver.

According to an embodiment, one receiver is provided with two-system IF circuits of IF circuits for receiving a television broadcast and IF circuits for receiving an audio broadcast, and the system is switched depending on the broadcast intended to be received. Due to this configuration, desired broadcasts can be selectively received by one receiver.

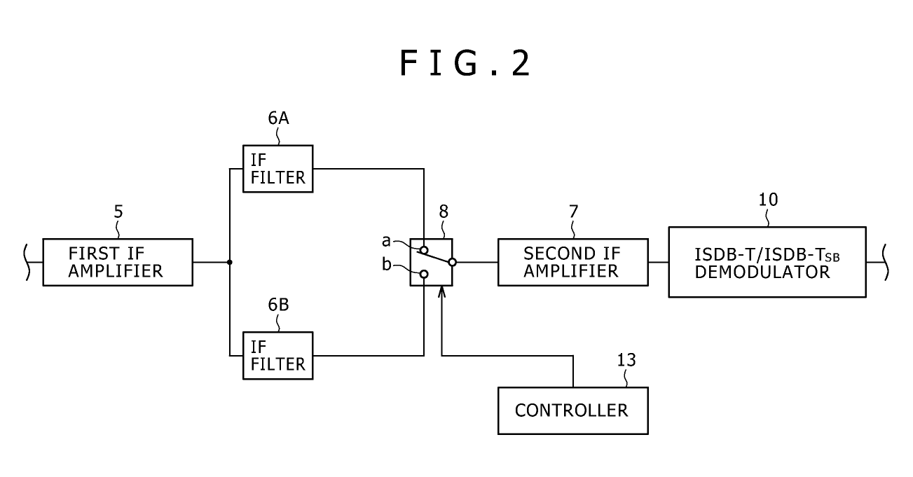

The configuration for switching broadcast reception to either one of digital terrestrial television broadcast reception and digital terrestrial radio broadcast reception may be provided downstream of the IF filters 6A and 6B, and can be realized by a circuit configuration like one shown in FIG. 2. In this configuration, it is sufficient for the number of the second IF amplifiers to be one, which can reduce the number of components in the circuit.

In general, a SAW filter with sharp attenuation ability is used as the IF filters 6A and 6B. In the above-described first embodiment, two kinds of band limitation filter should be used therefor, which leads to a large circuit scale. Furthermore, although it would also be possible to execute band limitation for an RF input in order to extract only the frequencies of a digital radio broadcast, it is difficult for this method to address the case where digital radio broadcasting is implemented by using the 8 CH. A digital terrestrial broadcast receiver to solve these problems will be described below.

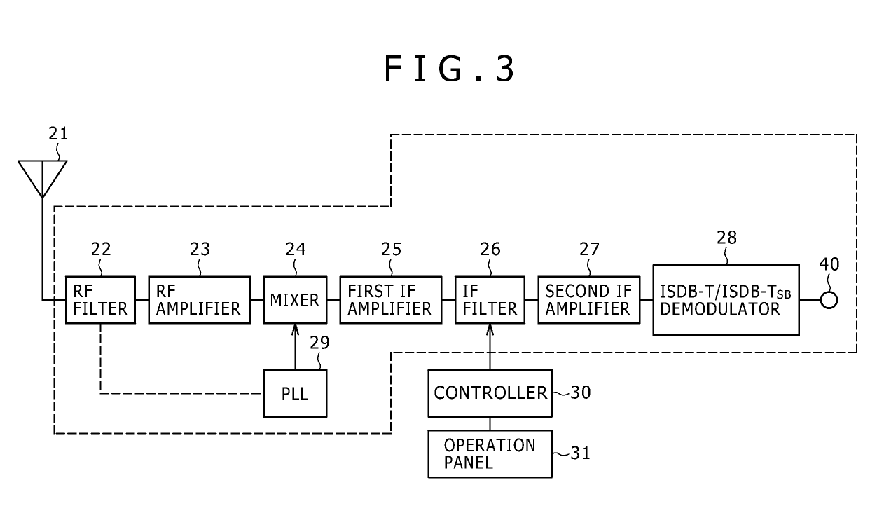

FIG. 3 is a block diagram showing the configuration of a digital terrestrial broadcast receiver according to another embodiment. The digital terrestrial broadcast receiver includes an antenna 21, an RF filter 22, an RF amplifier 23, a mixer 24, a first intermediate frequency (IF) amplifier 25, an IF filter 26, a second IF amplifier 27, an ISDB-T/ISDB-TSB demodulator 28, a PLL 29, a controller 30, an operation panel 31, and an output terminal 40. The part surrounded by the dashed line corresponds to a tuner module part that is formed of a one-system IF circuit and can deal with both digital terrestrial television broadcasts and digital terrestrial radio broadcasts.

The operation will be described below. A received signal (received RF signal) input from the antenna 21 is subjected to band limitation in the RF filter 22 that synchronizes with the PLL 29 in terms of the frequency, and then is amplified by the RF amplifier 23, followed by being input to the mixer 24. The mixer 24 mixes the received signal with a signal that is supplied from the PLL 29 and has a frequency changing depending on the selected channel to thereby convert the frequency of the received signal into a first IF of 57 MHz, which is lower than the reception frequency. This IF signal is amplified by the first IF amplifier 25 and then is subjected to band limitation in the IF filter 26, followed by being amplified by the second IF amplifier 27. The resultant signal is input to the ISDB-T/ISDB-TSB demodulator 28 and is demodulated therein. The ISDB-T/ISDB-TSB demodulator 28 outputs MPEG-2TS as the demodulated signal to the output terminal 40. The configurations and processes of the component for processing the MPEG-2TS and subsequent components are the same as those in the first embodiment, and therefore the illustration and description thereof are omitted.

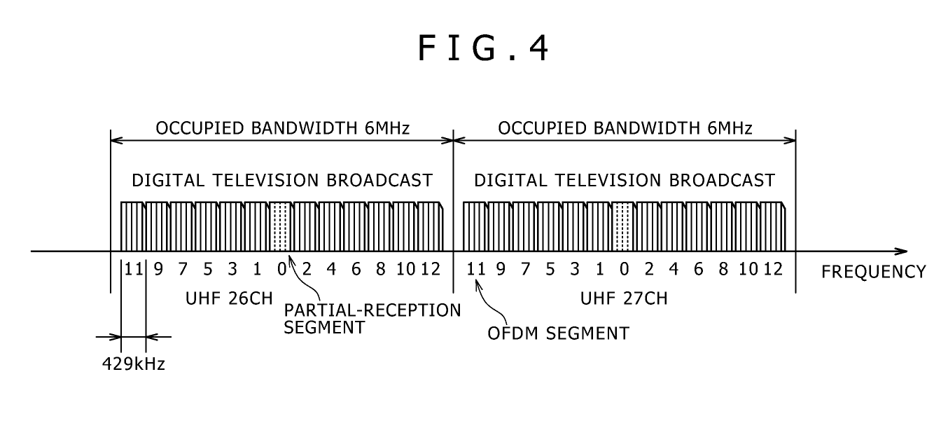

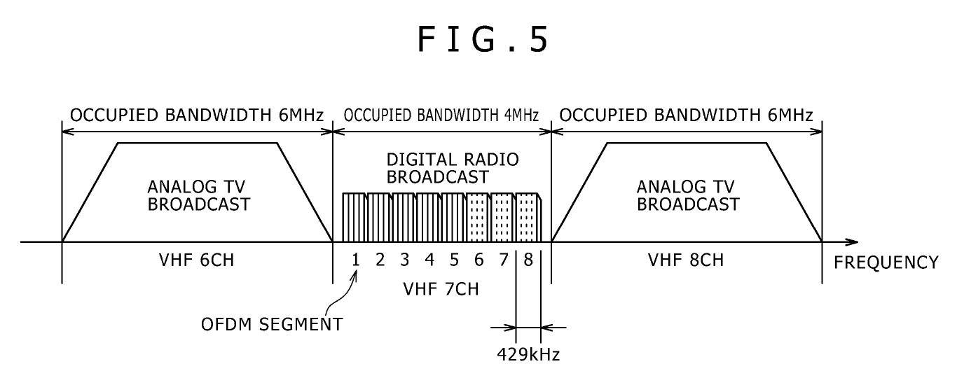

The IF filter 26 is a filter that can switch the passband in accordance with a band changeover signal from the controller 30. Therefore, when a digital terrestrial radio broadcast by the VHF 7 CH or 8 CH is received, the IF filter 26 limits the band to 4 MHz, and thereby can extract only eight segments shown in FIG. 5 and remove signals of the adjacent analog television broadcasts. The demodulator 28 demodulates, of the eight segments, any one segment or three segments including the one segment and adjacent segments, and outputs MPEG-2TS as the demodulated signal to the output terminal 40. On the other hand, when a digital terrestrial television broadcast is received, the IF filter 26 can switch the passband to 6 MHz in accordance with a band changeover signal from the controller 30, to thereby extract thirteen segments shown in FIG. 4 and remove adjacent signals. The limited bandwidth of the IF filter 26 can be switched by e.g. varying characteristics of this filter circuit.

One kind of filter that can switch its passband depending on which of a digital radio broadcast and digital television broadcast is received is employed as the IF filter 26, and thus the circuit scale of the tuner module can be significantly decreased compared with the first embodiment.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A digital terrestrial broadcast tuner module that allows reception of both a digital terrestrial television broadcast and a digital terrestrial radio broadcast, comprising:
a first frequency converter configured to convert a frequency of a received RF signal to thereby convert the received RF signal into a first intermediate frequency signal;
a first band limiter configured to convert the first intermediate frequency signal into a second intermediate frequency signal with a bandwidth for reception of a digital terrestrial television broadcast;
a second band limiter configured to convert the first intermediate frequency signal into a third intermediate frequency signal with a bandwidth for reception of a digital terrestrial radio broadcast;
a selector configured to select either one of the second intermediate frequency signal and the third intermediate frequency signal; and
a demodulator configured to demodulate the intermediate frequency signal selected by the selector.

2. The digital terrestrial broadcast tuner module according to claim 1, wherein
the bandwidth for reception of a digital terrestrial television broadcast is 6 MHz and the bandwidth for reception of a digital terrestrial radio broadcast is 4 MHz.

3. A digital terrestrial broadcast tuner module that allows reception of both a digital terrestrial television broadcast and a digital terrestrial radio broadcast, comprising:
a first frequency converter configured to convert a frequency of a received RF signal to thereby convert the received RF signal into a first intermediate frequency signal;
a first band limiter configured to convert the first intermediate frequency signal into a second intermediate frequency signal with either one of a bandwidth for reception of a digital terrestrial television broadcast and a bandwidth for reception of a digital terrestrial radio broadcast;
a selection controller configured to control the first band limiter so that the bandwidth of the second intermediate frequency signal is selected; and
a demodulator configured to demodulate the second intermediate frequency signal output from the first band limiter through selection under control by the selection controller.

4. The digital terrestrial broadcast tuner module according to claim 3, wherein
the bandwidth for reception of a digital terrestrial television broadcast is 6 MHz and the bandwidth for reception of a digital terrestrial radio broadcast is 4 MHz.

5. A digital terrestrial broadcast receiver that allows reception of both a digital terrestrial television broadcast and a digital terrestrial radio broadcast, comprising:
an antenna configured to receive a digital terrestrial television broadcast and a digital terrestrial radio broadcast;
a first frequency converter configured to convert a frequency of a received RF signal to thereby convert the received RF signal into a first intermediate frequency signal;
a first band limiter configured to convert the first intermediate frequency signal into a second intermediate frequency signal with a bandwidth for reception of a digital terrestrial television broadcast;
a second band limiter configured to convert the first intermediate frequency signal into a third intermediate frequency signal with a bandwidth for reception of a digital terrestrial radio broadcast;
a selector configured to select either one of the second intermediate frequency signal and the third intermediate frequency signal;
a demodulator configured to demodulate the intermediate frequency signal selected by the selector; and
a decoder configure to decode the demodulated signal and output an image signal and an audio signal.

6. The digital terrestrial broadcast receiver according to claim 5, wherein
the bandwidth for reception of a digital terrestrial television broadcast is 6 MHz and the bandwidth for reception of a digital terrestrial radio broadcast is 4 MHz.

7. A digital terrestrial broadcast receiver that allows reception of both a digital terrestrial television broadcast and a digital terrestrial radio broadcast, comprising:
an antenna configured to receive a digital terrestrial television broadcast and a digital terrestrial radio broadcast;
a first frequency converter configured to convert a frequency of a received RF signal to thereby convert the received RF signal into a first intermediate frequency signal;
a first band limiter configured to convert the first intermediate frequency signal into a second intermediate frequency signal with either one of a bandwidth for reception of a digital terrestrial television broadcast and a bandwidth for reception of a digital terrestrial radio broadcast;
a selection controller configured to control the first band limiter so that the bandwidth of the second intermediate frequency signal is selected;
a demodulator configured to demodulate the second intermediate frequency signal output from the first band limiter through selection under control by the selection controller; and
a decoder configure to decode the demodulated signal and output an image signal and an audio signal.

8. The digital terrestrial broadcast receiver according to claim 7, wherein
the bandwidth for reception of a digital terrestrial television broadcast is 6 MHz and the bandwidth for reception of a digital terrestrial radio broadcast is 4 MHz.
